(19) United States
(12) Patent Application Publication
(10) Pub. No.: US 2026/0359794 A1
(43) Pub. Date: Nov. 12, 2026

(54) EXAMINATION SCHEDULING OPTIMIZATION

(71) Applicant: KING SAUD UNIVERSITY, RIYADH (SA)

(72) Inventors: HAMOUD SULTAN BIN OBAID, RIYADH (SA); MOHAMMED ALI ALZAHRANI, RIYADH (SA); KHALID ABDULAZIZ ALGUMAISH, RIYADH (SA)

(21) Appl. No.: 19/196,560

(22) Filed: May 1, 2025

(51) Int. Cl. G06Q 10/109; G06Q 50/20; G09B 7/02

(52) U.S. Cl. CPC G06Q 10/1097; G06Q 50/205; G09B 7/02

(57) ABSTRACT

Examination scheduling optimization for scheduling qualification or certification examinations of candidates is performed using a Mixed Integer Linear Programming (MILP) mathematical model. For an identified qualification or certification examination type, demand, examination completion timeframes, examination administration capabilities, physical facility capacities, and examination specialty type for the examination type. The MILP mathematical model is constructed, in which the MILP model includes data collection and analysis from general data and further includes accounting from data representing said demand, examination completion timeframes, examination administration capabilities, physical facility capacities, and examination specialty type for the examination type. An evaluation using the MILP model is performed to optimize scheduling qualification or certification examinations of the candidates, while meeting criteria for required parameters, fixed parameters, or parameters representing difficult-to-adjust conditions.

### REFERENCE TO A SEQUENCE LISTING OR OTHER APPENDIX

Appendix 1 is a printout of Python code for a main model.

Appendix 2 is a printout of Python code for a first alternative model.

Appendix 2 is a printout of Python code for a second alternative model.

### BACKGROUND

### Technical Field

The present disclosure relates to examination scheduling optimization, for example for scheduling of national qualification or certification examinations of candidates. More particularly, the disclosure relates to implementation of a mathematical model for scheduling optimization which may be used for academic and certification qualification examination and testing.

### Background Art

Existing timetabling techniques, such as those used for scheduling exams for educational and certification institutions that rely on manual operations, are time consuming, and are often error-prone. These techniques thus often do not meet quality standards.

### SUMMARY

A Mixed Integer Linear Programming (MILP) mathematical model is used to optimize examination scheduling for qualification or certification examinations. One or more scheduling qualification or certification examinations of candidates are identified. Identification is made of an examination type, and demand, examination completion timeframes, examination administration capabilities, physical facility capacities, and examination specialty type for the examination type. The MILP mathematical model is constructed, wherein the MILP model includes data collection and analysis from general data and further includes accounting from data representing said demand, examination completion timeframes, examination administration capabilities, physical facility capacities, and examination specialty type for the examination type. An evaluation using the MILP model is performed to optimize scheduling qualification or certification examinations of the candidates, while meeting criteria for required parameters, fixed parameters, or parameters representing difficult-to-adjust conditions, wherein the predetermined optimization formula provides optimization values for each parameter.

### BRIEF DESCRIPTION OF THE DRAWINGS

FIG. 1 is a diagram showing an Operations Research Process.

FIG. 2 is a Gantt chart for the work plan of a project, “Graduation Project IE 496”.

FIG. 3 is a Gantt chart for the work plan of a project, “Graduation Project IE 497”.

FIG. 4 is a Project Flowchart for “Graduation Project IE 496”.

FIG. 5 is a Project Flowchart for “Graduation Project IE 497”.

FIG. 6 is a flow diagram of a collected data configuration.

FIG. 7 (prior art) is a sample of a schedule which can be manually implemented.

FIG. 8 is an example table, taken from a model for the month of July.

FIG. 9 is an example table, taken from a model for the month of August.

FIG. 10 is an example table, taken from a model for the month of October.

FIG. 11 is an example table, taken from a model showing a first alternative for the month of June.

FIG. 12 is an example table, taken from a model showing a first alternative for the month of July.

FIG. 13 is a graphic depiction of an example Days and Classes Chart for Part 1 examinations.

FIG. 14 is a graphic depiction of an example examination utilization chart for Part 1 examinations.

FIG. 15 is a graphic depiction of an example Days and Classes Chart for Board and Diploma Promotion Days.

FIG. 16 is a graphic depiction of an example utilization chart for Board and Diploma Promotion Days.

FIG. 17 is a graphic depiction of an example Days and Classes Chart for Examination Board and Diploma Final Exam.

FIG. 18 is a graphic depiction of an example utilization chart for Examination Board and Diploma Final Exam.

FIG. 19 is a graphic depiction of an example of a Days and Classes Chart for Fellowship and Diploma Promotion.

FIG. 20 is a graphic depiction of an example of a utilization chart for Fellowship and Diploma Promotion.

FIG. 21 is a graphic depiction of an example of a final Days and Classes Chart for Fellowship and Diploma Final Written Examination.

FIG. 22 is a graphic depiction of an example of a Final Utilization Chart for Fellowship and Diploma Final Written Examination.

### DETAILED DESCRIPTION

### Overview

Exam Timetabling Problem (ETP) refers to scheduling exams for educational and certification institutions. As a non-limiting example, the disclosed techniques can be implemented for the Saudi Commission for Health Specialties (SCFHS), as a certification institution. SCFHS relies on a manual and error-prone system that does not meet its quality standards. In order to address this, the present technique was implemented by programming a mathematical model using operations research tools, programmed in Python Gurobi software.

Python Gurobi software implements the Gurobi Optimizer platform. The Gurobi Optimizer is a prescriptive analytics platform and a decision-making technology developed by Gurobi Optimization, LLC, of Beaverton, Oregon, USA. The Gurobi Optimizer uses mathematical optimization to calculate the answer to a problem.

The disclosed techniques aim to optimize the operational and scheduling processes of SCFHS, which is responsible for organizing health sector exams. The significance of the disclosed techniques is evident in Saudi Arabia's “2030 vision for transforming the health sector”. Therefore, the initial focus of the disclosed techniques is to improve the SCFHS system.

Currently, the examination center scheduling is manually done, requiring significant time and effort. The disclosed techniques propose automating the scheduling process using a mathematical model. Implementing this model enables the scheduling process to be completed within 3.36 minutes, a remarkable improvement compared to the roughly one month required for manual scheduling. This model can save the time and effort required by the SCFHS team.

Additionally, the disclosed techniques offer two alternative solutions. The first alternative aims to balance resource utilization to enhance examinee satisfaction. In contrast, the second alternative focuses on maximizing the utilization of specific examination types to reduce the number of days required for scheduling. This reduction in scheduling time leads to decreased operational costs for SCFHS centers.

A Mixed Integer Linear Programming (MILP) modeling approach is used to optimize the scheduling process, providing decision-makers with a user-friendly tool; it generates a calendar schedule for SCFHS in 3.36 minutes, which is over 99% faster than their current traditional month-long system.

The model's first alternative was developed to achieve a better balance in average utilization, reducing it by up to 15.75% and contributing to SCFHS's goal of enhancing examinees' satisfaction. The second alternative maximizes utilization, reducing scheduling days by at least 6% and freeing up to 25% of scheduling days from the total scheduling period for some programs.

The disclosed technology relates to a mathematical model for scheduling optimization for examination and testing administration in which the MILP model advantageously constructed using Python Gurobi. Construction of the MILP model includes data collection and analysis from general data and further includes accounting for examination type, demand, examination completion timeframes, examination administration capabilities, and examination specialty type.

The MILP model formulation includes the following parameters: M set of months, W set of weeks, D set of days, DI set of day-indices, MWDI a four dimensional calendar value set for each month, week, day in a week, and an index of day pairs, S set of specialties, P set of programs, Q set of steps, SPQ a three dimensional set for each program and step of any specialty, PQ a two dimensional set for each program of each program and step pairs, DEM_{spq} the demand of each specialty for a specific program and step, CAP the capacity of all centers, Tcᵢ the total number of classification exams in a month I, Tlᵢ the total amount of licensure exams in a month I, epq the number of exams for any program p and step q, OD_{mwdi} 1 if an index i for a day d, week w, and month m is an operating day, 0 otherwise. The model formulation includes decision variables and constraints and solved for minimization.

In development, the MILP model was used for scheduling optimization for examination and testing administration at the Saudi Commission of Health Specialties. The MILP mathematical model was advantageously constructed using Python Gurobi.

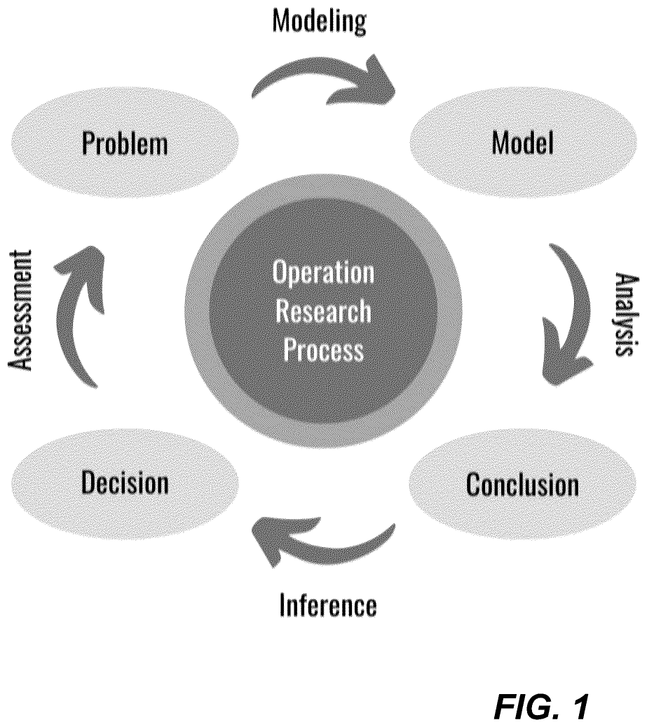

Operations Research (OR) is the study of how to form mathematical models of complex engineering and management problems and how to analyze them to gain insight into possible solutions. FIG. 1 is a diagram showing an Operations Research Process. The diagram shows the process of OR, which starts with formulation or modeling as the first step in the process. The variables define and quantify the linkages to explain important system behavior accurately. Based on the linkages, an analysis is performed, in which mathematical models are used to provide conclusions based on that model.

To finish the process, one would participate in the inference as a “sanity check” to determine if the conclusions drawn from the model are meaningful enough to infer decisions for the person or people with the problem. The assessment decisions deduced in this way are often judged to be either extreme or insufficient for implementation. The cycle continues as new ideas prompt changed modeling.

Optimization modeling in mathematics aims to identify the ideal maximal or minimal value of a complex equation. By optimization modeling, we mean the use of mathematical methods to address problems based on specific features by implementing Linear Programming (LP), Integer Linear Programming (ILP), and Goal Programming (GP).

Linear Programming (LP) is one of the tools that operation researcher utilizes, and when confronted with highly complicated practical issues, linear programming can be seen as a key component of a significant revolutionary development that has enabled humanity to set broad objectives and map out a path of particular decisions to make in order to best accomplish those objectives.

Integer Linear Programming (ILP) is implemented using integer variables with linear constraints allow for modeling a remarkably large class of real-world issues. A Pure Integer Problem (PIP) represents a model that contains only integer variables, but integer variables are more frequently present, along with real variables. A model like this is known as a mixed integer programming (MIP) model. There is also a binary programming form, which yields decisions based on the numbers 1, 0 “yes or no” Decision.

Goal Programming (GP) is a multi-objective programming technique that is derived from LP. It strives to provide a result that fulfills the constraints as feasible as possible rather than maximizing a clearly defined function.

Motivation for addressing the problem was based on “The Saudi Arabian 2030 Vision, which emphasizes the importance of the society and health sector as well as the potential of the younger generation, which are considered to be the wealth and the power of the country. That in-turn created a motivation to ensure that any effort should be directed to any critical sector in which any little change might have a high impact on their work and should be relevant to the specialty of industrial engineering and, more specifically original research. As the health sector is one of the pillars of the transformation strategy, it was decided to look for an opportunity in one of the main commissions and organizations in the health sector to apply engineering knowledge, with the aim of increasing the performance of these organisations, which may take the form of enhancing the scheduling process.

Resource scheduling is a decision-making process that is used on a daily, weekly, monthly, or annual basis in almost all manufacturing and services industries. It is concerned with allocating resources to achieve specific tasks in a given time and aims to optimize one or more objectives. The resources and tasks have various forms and types in any organization. The resources can be machines in a workshop, workers at a company, seats in an examination center, etc. The tasks can be operations in a production process, phases in a consulting project, or supervision of an exam. Tasks are prioritized depending on the importance and the penalties for the lateness of completing the task after a certain date. The objectives of scheduling also vary and take various forms. One objective may be the minimization of the completion time of the last task, and another may be the minimization of the number of tasks completed after their respective due dates.

Since the number of examinees in the health sector is increasing, and in order to contract with other organizations to conduct their exams at convenient times, the existing scheduling process is manual. Consequently, it takes time and effort for the person responsible for scheduling, and there is a possibility of human error, considering the requirement to schedule more than two hundred specialties and over one hundred thousand exams in a calendar year.

The disclosed techniques aim to develop a mathematical model that can automate the scheduling process and solve examination scheduling problems in a shorter time while avoiding the possibility of human error in manual scheduling. The disclosed techniques also minimize unscheduled time and increase the utilization of the examination center recourses while maintaining the examinee's satisfaction. Accordingly, it is desired to build a mathematical model that enhances the scheduling process for the SCFHS centers that cover the whole country, which will lead to an improvement in the utilization of the examination centers.

The disclosed technique links all systems in one network. The process starts with the registration of the examinees indicating their level and specialty to be grouped with other examinees who are similar, or the ones who pass one level and are registered in the next level. The examinees are grouped with the other examinees of the same specialty and level, and who newly registered or passed the previous level. After the registration closes, the administrator/manager only updates the input of the system with the new number of examinees for each specialty and level. The input of number of examinees in all specialties and levels is passed to the scheduling engine, which is composed a processor, a memory, an executable code that is written in Python code (Python Gurobi), and a MILP solver that uses the MILP model to solve mixed integer linear programs.

According to the disclosed technique, an examination scheduling system receives the number of examinees in all specialties and levels, staff requirements, number of seats in all centers, and associated scheduling rules to be considered in the scheduling process. The system relies on the MILP model using this information, which decomposes the problem into a set of phases to reduce complexity. The output of each phase is fed into the next phase resulting in a set of schedules for different exam types and different level of details.

In a non-limiting example, the scheduling engine passes the pre-written code to the MILP solver with the new input data to be solved in three phases:
Phase 1: Optimize the number of days required for each examination.
Phase 2: Optimize the written examination schedules given the number of days from Phase 1, demand and capacity.
Phase 3: Optimize the clinical examinations based on written examination schedules set in Phase 2.

In Phase 1, the model finds the minimal number of days required to perform the written examinations for each specialty based on the available number of seats and the number of examinees. The number of days provides examination completion timeframes. In Phase 2, the model considers the number of days in the process of scheduling the written examinations in addition to scheduling the on-going examinations that are scheduled around the year. After setting the written examinations, the model passes these dates to the Phase 3 of the model to schedule the clinical examinations.

In a non-limiting example, the clinical examinations must take a place two weeks after the written examinations for each specialty, so the examiners have a sufficient time for grading. The result of Phase 3 is a set of schedules that can be classified as master and detailed for the written and clinical examinations. The master schedules show the overall exam dates for each program, level, and type, while the detailed schedules show the examinee numbers for each specialty, program, level, and type. Then these schedules are passed to the network to be passed to the exam centers to be prepared for the examinations (invigilators, examiners, clinics, etc.). A copy of the schedules is also passed to the proctors or reviewers assigned to these examinations. Finally, a copy of the exam schedules reaches the end of the loop where it is shown in the system for the examinees to be prepared for the exam and be prepared to travel if the examination center is in a different city.

The disclosed technique links all systems to be automated for fewer errors, higher efficiency, and less time and cost. The examinees may be given the opportunity to edit or give their preferences after the schedule is optimized where it takes the entire loop attempting to satisfy the examinees' preferences.

### Methodology

The methodology includes specific steps for an optimization problem as an operation research project. These steps are as follows:
Identify the system or part of the system to be studied and define the objective.
Collect the relevant data and analyze it.
Develop an optimization model by formulating the objective and the constraints.
Build the code using appropriate optimization software.
Verify the model by debugging the whole procedure.
Validate the model by comparing it with the actual system.
Report the results along with the recommendations.

Constraints of the technique include following restriction, which are anticipated:
Communication with the commission for data collection is challenging due to confidentiality and the company's high workload.
The coordinator from the company does not have full access to the needed historical data, so it takes more time to obtain it, which hinders the progress of the project and the analysis of schedules.
Since team members are students, they cannot visit the company frequently to collect and review data. In addition, they cannot implement everything they want to achieve the project's goals.

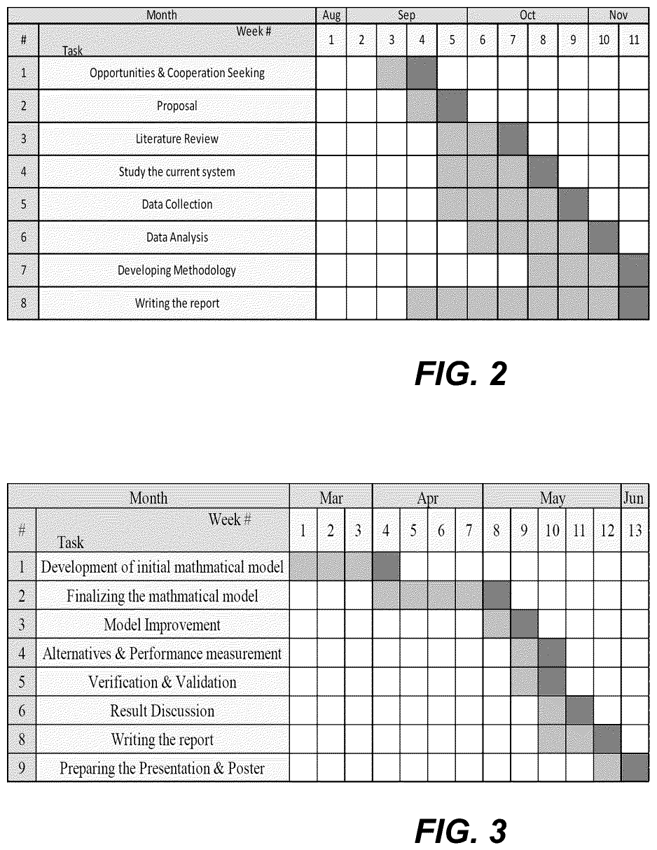

In order to demonstrate the disclosed techniques, two project plans were developed, identified as “Graduation Project IE 496” and “Graduation Project IE 497”. FIG. 2 is a Gantt chart for the work plan of a project, “Graduation Project IE 496”. FIG. 3 is a Gantt chart for the work plan of a project, “Graduation Project IE 497”.

Graduation project IE 496 is a first phase, and is centered around the theoretical part, which includes the literature review on the topic, gathering the data, preparing it for implantation in the project's second phase, and developing the methodology. Graduation project IE 496 is a second phase, which includes mathematical modelling for implementation of the project.

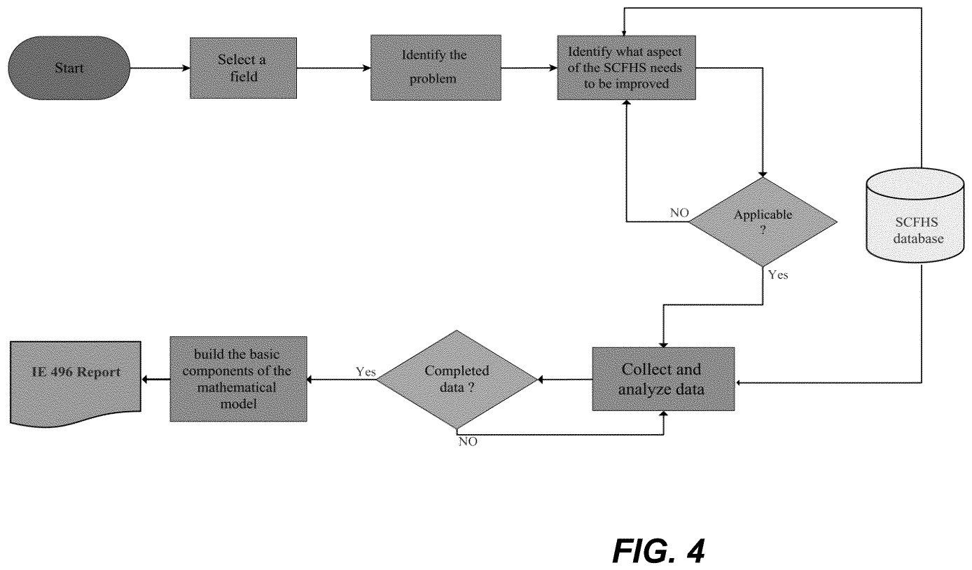

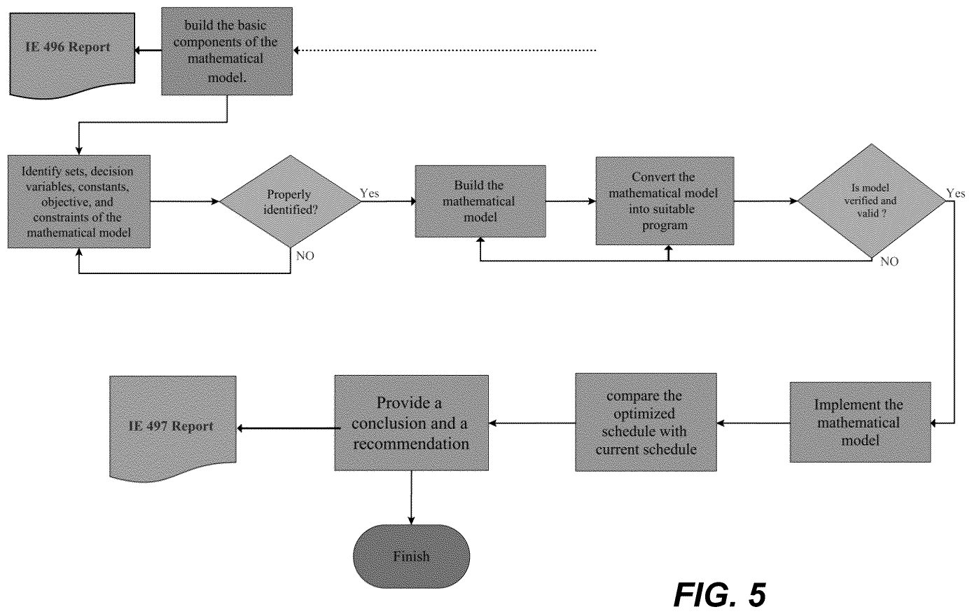

The scheduling problem is divided into “Graduation Project IE 496” and “Graduation Project IE 497”. FIG. 4 is a Project Flowchart for “graduation project IE 496”. FIG. 5 is a Project Flowchart for “graduation project IE 497”. “Graduation Project IE 496” and “Graduation Project IE 497” are performed sequentially.

A variety of suitable optimization tools can be used to implement the disclosed technique, including Cplex, Lingo, Excel OpenSolver, and Python Gurobi.

LINGO is a complete tool to develop and solve linear, nonlinear (convex and nonconvex/Global), quadratically constrained, second-order cone, semi-definite, stochastic, and integer optimization models more quickly, simply, and effectively. A powerful language for expressing optimization models, a fully featured environment for creating and editing problems, and a collection of quick built-in solvers are all included in LINGO's fully integrated package.

Excel OpenSolver is an open-source Excel add-in that enables users of spreadsheets to solve their LP/IP models using the COIN-OR CBC solver. Most existing LP and IP models may be solved with OpenSolver and the default Excel Solver without modification. OpenSolver, on the other hand, does not have any of the size restrictions present in Solver and can thus solve larger models; but, when solving large models with OpenSolver, it will take some time to obtain the optimal answer.

Cplex is a high-performance optimization solver for linear, mixed-integer and quadratic programming is the IBM Cplex optimizer. The Cplex optimizer interfaces with the C++, C#, Java, and Python languages through a concrete modeling layer. For debugging and other uses, a separate interactive optimizer executable is available.

Python Gurobi provides mathematical modeling. Python Gurobi is a robust and well-supported programming language. It has unique characteristics that make it simple to create and maintain optimization models. Python Gurobi can solve linear and mixed-integer programming in a short time when we compare it with other software.

To build the model, various types of data must be collected to represent the SCFHS processes accurately. This includes capacity data, demand data (e.g., the number of examinees for each specialty), and constraints derived from organisational policies and procedures.

The scheduling process for all SCFHS centers is centralized at a head examination office. Once the head examination office has approved the scheduling, it applies to all SCFHS centers. In the initial demonstration, the SCFHS has four centers, all operating during the same hours from Sunday to Thursday.

Although each SCFHS center has a different capacity, this does not affect the scheduling process, as the process is the same for all centers. If the capacity for a specific examination type is full for any of the four centers on a given day, the examinee must travel to another center to take the exam. Therefore, the overall capacity (e.g., number of seats) can be the most critical factor. Thus, the MILP model to minimize a summation of the parameters according to a predetermined optimization formula, while meeting criteria for required parameters, fixed parameters, or parameters representing difficult-to-adjust conditions.

Each program type comprises a list of specialties, each with a specified number of examinees known as the demand. The SCFHS provides the demand numbers for each specialty, considering various factors, such as the number of students or examinees who failed the examination in the previous year.

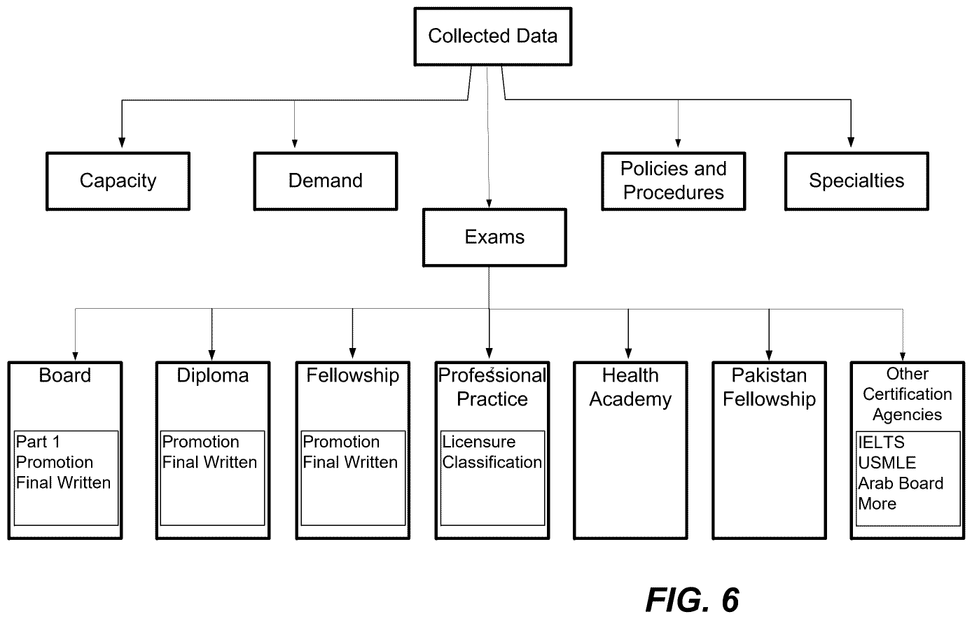

Table 1 illustrates three types of exams that, in the example, must be scheduled every calendar year, using relevant parameters:
1. Postgraduate exams: These exams are scheduled based on the starting date of each program (i.e., the examination must be taken after nine or ten months of the program's commencement). Two programs fall under this category: Board and Diploma, and Fellowship and Diploma. The Diploma program is divided into Board and Fellowship because some diploma exams are scheduled with Board while others are scheduled with Fellowship.
2. Professional Practice Exams These exams are conducted throughout the year, except for one week per month for License exams and two days per month for certification exams.
3. Fixed date exams: The scheduling of these exams follows a fixed data schedule provided by the SCFHS. In the example, the exams fall into two categories: Health Academy and Pakistan Fellowship. FIG. 6 is a flow diagram of a collected data configuration.

The table shows a sample of the demand for some specialties:

TABLE 1
Example of Demand

| | | | Total umber of |
|---|---|---|---|
| | Percentage of | | examinees after |
| Name of the | failures in previous | Expected total | adding expected |
| specialty | year | change | change |
| X | 0% | 0% | +16 |
| Y | 4% | 4% | +73 |
| Z | 22% | 22% | +106 |
| W | 0% | 10% | +3 |
| V | 29% | 29% | +128 |

Some of the constraints and considerations that need to be considered when formulating the problem and modeling can be divided into overall categories of Completion, Capacity, and Specification and Exclusion. These can be further characterized to include:

### Completion:

All exams are to be scheduled within a year.
All exams are scheduled after the starting date.
All specialties examinees are allocated to their perspective exams.

### Capacity:

The exams should be within the working days; hence the Professional Development Day and all other official off days are excluded from the set of available days.
The number of examinees is less than or equal to the number of available seats.

### Specification and Exclusion:

All specialties with the same examination type and program are held on the same day/s, except the Diploma.
Exams for certain Diploma specialties are held with the fellowship and the rest with the board program.
Professional Practice exams run throughout the year except for one week/month for the License exams, and two days per month for Certification exams.
Post-graduation programs are scheduled according to the following sequence:
   1. Part 1
   2. Promotion
   3. Final Written

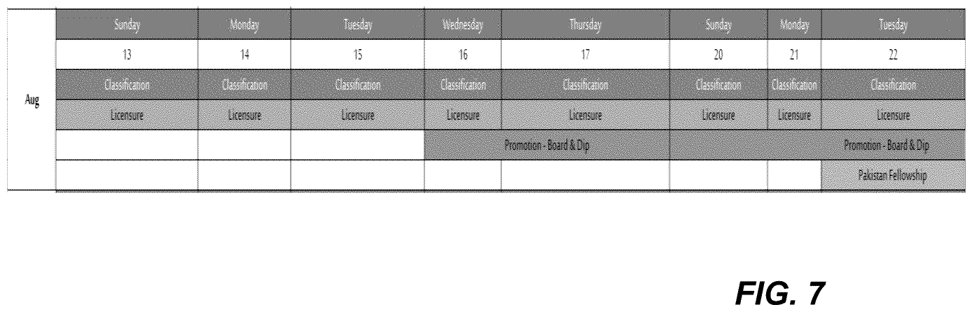

FIG. 7 (prior art) is a sample of a schedule which can be manually implemented. The disclosed technology is intended to more efficiently implement the results of a manually implemented schedule. The figure illustrates a sample of scheduled exams that were manually conducted by SCFHS staff.

A mathematical model used in implementing the disclosed technique is formulated to contain parameters, decision variables, objective functions, and constraints, as well as a description of the job of each element of the model. The mathematical model aims to schedule all the exams within the given period while avoiding all possible overlapping and conflicts.

An example mathematical matter uses the following parameters:
M: set of months (1 . . . m)
W: Set of weeks (l . . . w)
D: Set of days (l . . . d)
DI: Set of days-indices (1 . . . i)
MWDI: Four-dimensional set for each month, week, day in a week and index of a day pairs.
S: Set of specialties (1 . . . s)
P: Set of programs (1 . . . p)
Q: Set of steps (1 . . . q)
SPQ: three-dimensional set for each program and step of any specialty
PQ: two-dimensional set for each program and step pairs.
DEM_{spq}: The demand of each specialty for specific program, and step
CAP: The Capacity of all centers
Tc_{I}: The total number of classification examination in a month I
Tlᵢ: The total number of Licensure examination in a month I
ep_{q}: Number of exams for any program p and step q
OD_{mwdi}: 1 if an index i for a day d, week w and month m is an operating day, 0 otherwise.

### Decision Variables are:

X_{p,q,w,d,i}: 1, if the program p with step q Scheduled in week w on day d indicated by index i, 0 otherwise.
Y_{s,p,q,w,d,i}: 1, if the specialty s in program p with step q Scheduled in week w on day d indicated by index i, 0 otherwise.
Z_{p,q,w,d,o}: 1, if the program p with step q starts from week w on day d indicated by day-index i, 0 otherwise.
U_{w,d,i}: Percentage of the utilized capacity in week w on day d indicated by index i.

The objective function can be expressed as

$$Minimize z = {\sum }_{w , d , i ∈ MWDI} {\sum }_{p , q ∈ P Q} {X}_{p , q , w , d , i} + {\sum }_{w , d , i ∈ MWDI} {\sum }_{p ∈ ( 5 , 6 )} {X}_{p , 1 , w , d , i} * i + {\sum }_{w , d , i ∈ MWDI} {\sum }_{s , p , q ∈ SPQ} {Y}_{s p , q , w , d , i} + {\sum }_{w , d , i ∈ MWDI} {U}_{w , d , i}$$

The constraints are resolved as:

Y_{s,p,q,w,d,i}≤X_{p,q,w,d,i}, ∀s,p,q∈SPQ, ∀m,w,d,i∈MWDI (1)

$${\sum }_{s , p , q ∈ S P Q} {Y}_{s , p , q , w , d , i} * D E {M}_{s , p , q} \leq C AP * {OD}_{m , w , d , i} ∀ m , w , d , i ∈ MWDI \qquad ( 2 )$$

$${\sum }_{p , q ∈ P Q} {X}_{p , q , w , d , i} \leq C AP * {OD}_{m , w , d , i} ∀ m , w , d , i ∈ MWDI \qquad ( 3 )$$

$${\sum }_{mo , w , d . i ∈ MWDI} {Y}_{s , p , q , w , d , i} * D E {M}_{s , p , q} \geq D E {M}_{s , p , q} ∀ s , p , q ∈ SPQ \qquad ( 4 )$$

$${\sum }_{p ∈ ( 1 , 2 )} {X}_{p , q , w , d , i} \leq 1 ∀ q ∈ ( 1 … 5 ) , ∀ m , w , d , i ∈ MWDI \qquad ( 5 )$$

$${\sum }_{m , w , d , i ∈ MWDI} {Z}_{p , q , w , d , i} = 1 ∀ p , q ∈ P Q \vert p \leq 2 \qquad ( 6 )$$

$${\sum }_{p , {q}^{′} ∈ PQ \vert p \leq 2} {Z}_{p , {q}^{′} , {w}^{′} , {d}^{′} , {i}^{′}} \leq {\sum }_{p , q ∈ P Q \vert p \leq 2} {\sum }_{m , w , d , i ∈ MWDI} {Z}_{p , q , w , d , i} \qquad ( 7 )$$

$$∀ {q}^{′} = q + 1 , q ∈ ( 1 … 5 ) ∀ {m}^{′} , {w}^{′} , {d}^{′} , {i}^{′} ∈ MWDI \vert {i}^{′} > i , i \geq 2$$

$$( 1 - {Z}_{p , q , w , d , i} ) * 500 \geq {\sum }_{s ∈ S P Q} {Y}_{s , p , q , {w}^{′} , {d}^{′} , {i}^{′}} ∀ p , q ∈ P Q \vert p \leq 2 \qquad ( 8 )$$

$$∀ m , w , d , i ∈ MWDI ∀ {m}^{′} , {w}^{′} , {d}^{′} , {i}^{′} ∈ MWDI \vert {i}^{′} \geq i + {e}_{p q}$$

$$( 1 - {Z}_{p , q , w , d , i} ) * 500 \geq {\sum }_{s ∈ S P Q} {Y}_{s , p , q , {w}^{′} , {d}^{′} , {i}^{′}} ∀ p , q ∈ P Q \vert p \leq 2 ∀ m , w , d , i \qquad ( 9 )$$

∈MWDI ∀m′,w′,d′,i′∈MWDI|i′<i

Z_{p,q,w,d,i}≤OD_{m′,w′,d′,i′}∀p, q∈PQ|p≤2,

m,w,d,i∈MWDI ∀m′,w′,d′,i′∈MWD|i′≤i+e_{pq},i′≥i (10)

X_{p,q,w,d,i}+(1−OD_{m,w,d,i})≥X_{p,q,w′,d′,i′}∀p,q

∈PQ|p∈(5,6)∀m″∈M ∀m,w,d,i∈MWDI|m″=m,

m′,w′,d′,i′∈MWDI|m′=m, i′=i+1 (11)

$${\sum }_{w , d , i ∈ MWDI} {X}_{1 , 1 , w , d , i} = 0 ∀ m ∈ M / ( 6 , 7 ) \qquad ( 12 )$$

$${\sum }_{w , d , i ∈ MWDI} {X}_{1 , 2 , w , d , i} = 0 ∀ m ∈ M / ( 8 , 9 ) \qquad ( 13 )$$

$${\sum }_{w , d , i ∈ MWDI} {X}_{1 , 3 , w , d , i} = 0 ∀ m ∈ M / ( 9 , 10 ) \qquad ( 14 )$$

$${\sum }_{w , d , i ∈ MWDI} {X}_{2 , 4 , w , d , i} = 0 ∀ m ∈ M / ( 11 ) \qquad ( 15 )$$

$${\sum }_{w , d , i ∈ MWDI} {X}_{2 , 5 , w , d , i} = 0 ∀ m ∈ M / ( 12 ) \qquad ( 16 )$$

$${\sum }_{w , d , i ∈ MWDI} {Y}_{206 , 5 , 1 , w , d , i} = {Tc}_{m} ∀ m ∈ M \qquad ( 17 )$$

$${\sum }_{w , d , i ∈ MWDI} {Y}_{207 , 6 , 1 , w , d , i} = {Tl}_{m} ∀ m ∈ M \qquad ( 18 )$$

$${\sum }_{w , d , i ∈ MWDI} {Y}_{208 , 7 , 1 , w , d , i} = 2 ∀ m ∈ M \qquad ( 19 )$$

$${Y}_{s , p , q , w , d , i} \geq 1 ∀ s , p , q , w , d , i ∈ FIXEDEXAM \qquad ( 20 )$$

$${\sum }_{s , p , q ∈ S P Q} {Y}_{s , p , q , w , d , i} * D E {M}_{s , p , q} \leq C A P * {U}_{w , d , i} ∀ m , w , d , i ∈ MWDI \qquad ( 21 )$$

X_{s,p,q,w,d,i}∈{0,1} ∀p, q∈PQ, ∀m,w,d, i∈MWDI (22)

Y_{s,p,q,w,d,i}∈{0,1} ∀s,p, q∈SPQ, ∀m,w,d, i∈MWDI (23)

Z_{s,p,q,w,d,i}∈{0,1} ∀p,q∈PQ, ∀m,w,d, i∈MWDI (24)

U_{s,p,q,q,d,i}∈{0,1} ∀m,w,d, i∈MWDI (25)

### Implementation

The objective function is to minimize all the scheduled exams and schedule the professional practice exams as close to each other as possible. Constraint (1) is responsible for connecting the two variable X and Y. Constraint (2) ensures that for any operational day, the total examination demand does not exceed the capacity. The third constraint (3) ensures that variable X is not scheduled on non-operational days. Constraint (4) ensures any examination is at least scheduled once while neglecting any examination without a demand. The fifth constraint (5) ensures that postgraduate programs do not overlap. The following constraint (6) assigns the value of the variable Z which indicates the start of the scheduling for postgraduate programs. Constraint number (7) ensures that the scheduling of the start of any postgraduate program follows step Q by ensuring that all the previous steps start before starting the next step. Constraints (8) and (9) limit postgraduate exams to be scheduled within a period (e) which is obtained from the supporting model. Constraint (8) limits the days after the period while (9) limit all the days before the start of the examination period. Constraint (10) ensures that a non-operational day does not interrupt the postgraduate examination period. Constraint (11) ensures that for each month, the professional practice examination is sequenced without any stopping except for non-operational days. The next constraints (12-16) are limiting the scheduling to a certain period which is unique for each program. The following two constraints (17,18) ensure the number of professional practice exams is equivalent to the data for each month. The constraint (19) each month schedules the professional development two days off by using the whole capacity. Constraint (20) schedules the predetermined fixed exams based on the data. Finally, constraint (21) determines the utilization of capacity for each day.

The model verification is considered to be reached when it is precise, error-free, and behaves as expected; in other words, the model is verified once it provides a result, which only happens after debugging the whole code and ensuring the model is reflecting the mathematical model while also adapting to the programing language and the data structures. The bottom-up approach for programming allows the debugging process to go through each constraint or change, which eases the verification compared to stacking all the constraints together and then attempting to debug the whole model, which will have to deal with more errors and higher complexity with the combined effects of multiple errors. The model precision, on the other hand, is tested by running the code multiple times and providing the same or similar results that only differ on the scheduling date but still in the same period and following all the constraints. As mentioned, the MILP model minimizes a summation of the parameters according to a predetermined optimization formula, while meeting criteria for required parameters, fixed parameters, or parameters representing difficult-to-adjust conditions.

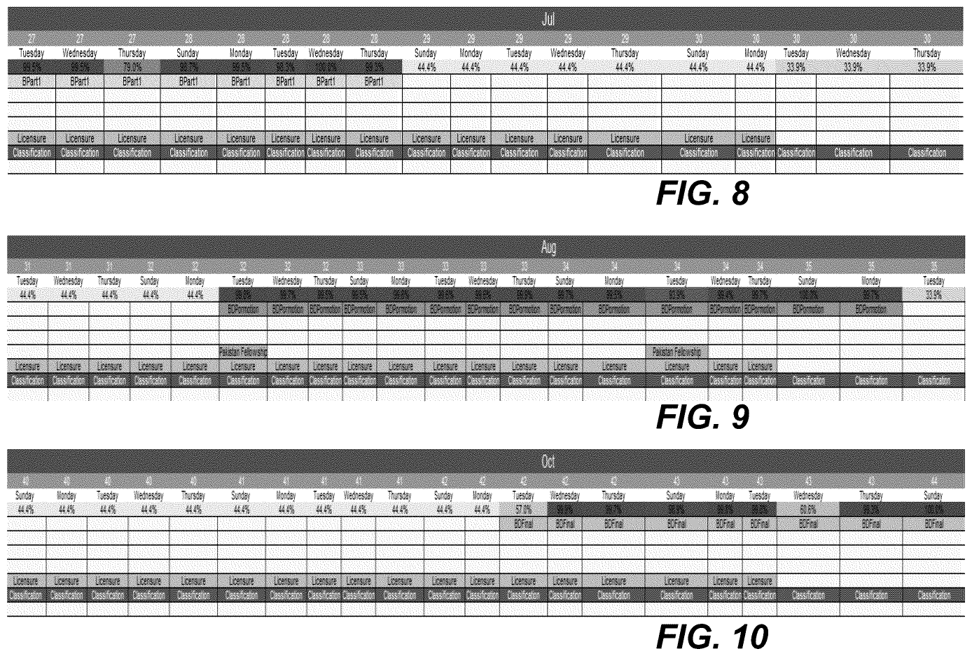

FIGS. 8-10 are example tables showing results for scheduling in three different months. FIG. 8 is an example table, taken from a model for the month of July. FIG. 9 is an example table, taken from a model for the month of August. FIG. 10 is an example table, taken from a model for the month of October. The model correctly represented the SCFHS schedule regarding all the applicable constraints, and yielded accurate scheduling.

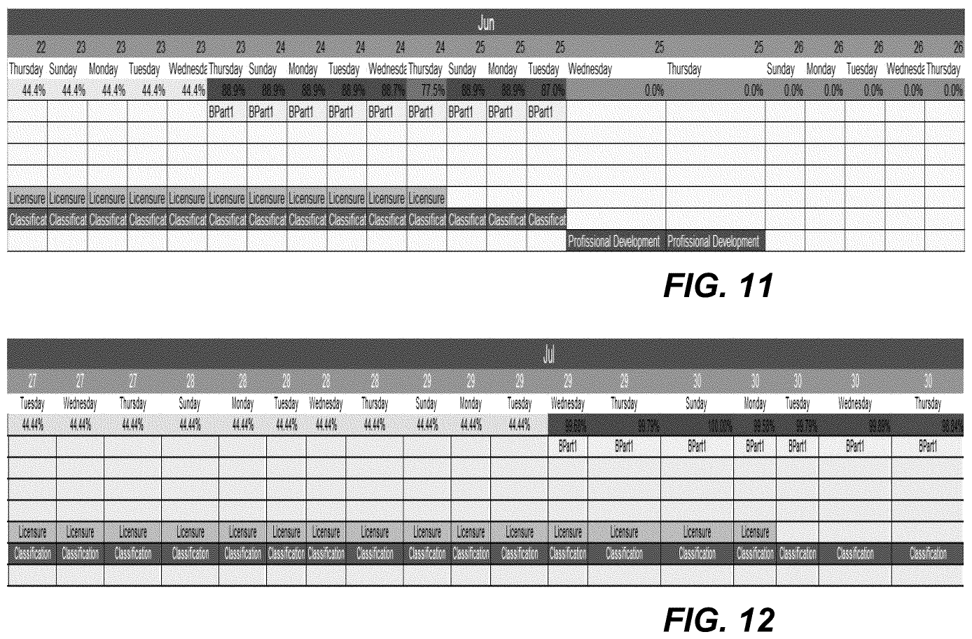

FIGS. 11 and 12 are example tables showing first alternatives for two different months. FIG. 11 is an example alternative table for the month of June. FIG. 12 is an example alternative table for the month of July. These tables represent two alternative solutions that follow the same overall structure of the model, but with additional constraints and objective functions. Each alternative yields a similar result with some differences that aim to contribute to SCFHS strategic goal of improving the satisfaction of the examinees.

In the first alternative, represented by FIG. 11, there is an additional constraint that specifies the maximum level of all-month utilization, and the objective function also aims to minimize that level to get the most balanced schedule within all constraints. A second alternative, represented by FIG. 12, aims to maximize the utilization so that the examination periods for postgraduate programs can be scheduled within the least number of days, within the capacity of the testing facility.

Evaluation of the model and alternative is performed based on the following performance measures:
The total time needed to complete the scheduling process.
The average utilization for each postgraduate examination period.
The maximum utilization for each postgraduate examination period.
Number of days for each postgraduate examination period.
The average number of classes across all centers (class with 29 seats).

Table 2 shows comparisons between total scheduling times. The table shows the total scheduling time for the current system and all the different alternatives of the mathematical model. It was determined that the initial approach required more time to build the schedule compared to the alternative, which takes less than 4 minutes while the first alternative takes around 10 minutes due to the complex objective function that requires the model to get the least utilization while achieving all the other objectives:

TABLE 2
comparisons between total scheduling times:

| | SCFHS | | | |
|---|---|---|---|---|
| | (manual | | | |
| MODEL | entry) | Main model | Alternative 1 | Alternative 2 |
| Time | 1 month | 3.36 minutes | 10.22 minutes | 3.38 minutes |

Table 3 shows Board Part 1 examination comparisons, representing the models' performances compared to the current system for Board Part 1 examination period using the main model, Alternative 1 and Alternative 2:

TABLE 3
Board Part 1 examination comparisons

| | SCFHS | | | |
|---|---|---|---|---|
| | (manual | | | |
| MODEL | entry) | Main model | Alternative 1 | Alternative 2 |
| Avg. | 98.8% | 96.7% | 87.4% | 99.7% |
| utilization | | | | |
| Max. | 120.5% | 100% | 88.9% | 100% |
| utilization | | | | |
| No. days | 8 | 8 | 9 | 7 |
| Avg. no. | 33 | 32 | 29 | 33 |
| classes | | | | |

The table shows that Alternative 2 has seven days which is the least number of scheduling days for Part 1 examinations compared to other models and the current system. The first alternative has less than 90% utilization which is lower than all other models. The current system has utilization above 100% which is not a feasible system under normal circumstances.

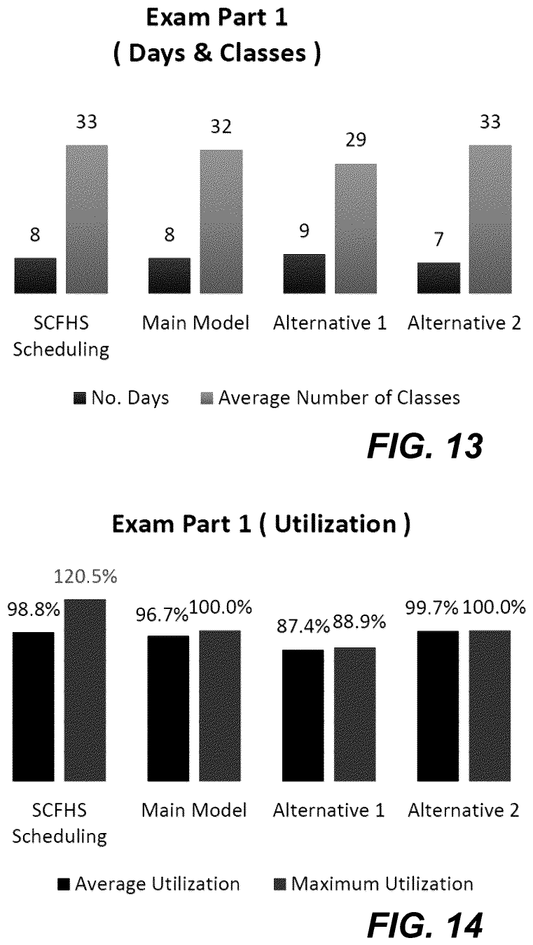

FIG. 13 is a graphic depiction of an example examination Days and Classes Chart for the main model, Alternative 1 and Alternative 2 for Part 1 examinations. FIG. 14 is a graphic depiction of an example examination utilization chart for the main model, Alternative 1 and Alternative 2 for Part 1 examinations.

Table 4 shows board and diploma promotion comparisons for the main model, Alternative 1 and Alternative 2:

TABLE 4
board and diploma promotion comparisons

| | SCFHS | | | |
|---|---|---|---|---|
| | (manual | | | |
| MODEL | entry) | Main model | Alternative 1 | Alternative 2 |
| Avg. | 114.7% | 99.3% | 99.3% | 99.4% |
| utilization | | | | |
| Max. | 203.7% | 100% | 99.5% | 100% |
| utilization | | | | |
| No. days | 15 | 15 | 15 | 14 |
| Avg. no. | 38 | 38 | 33 | 33 |
| classes | | | | |

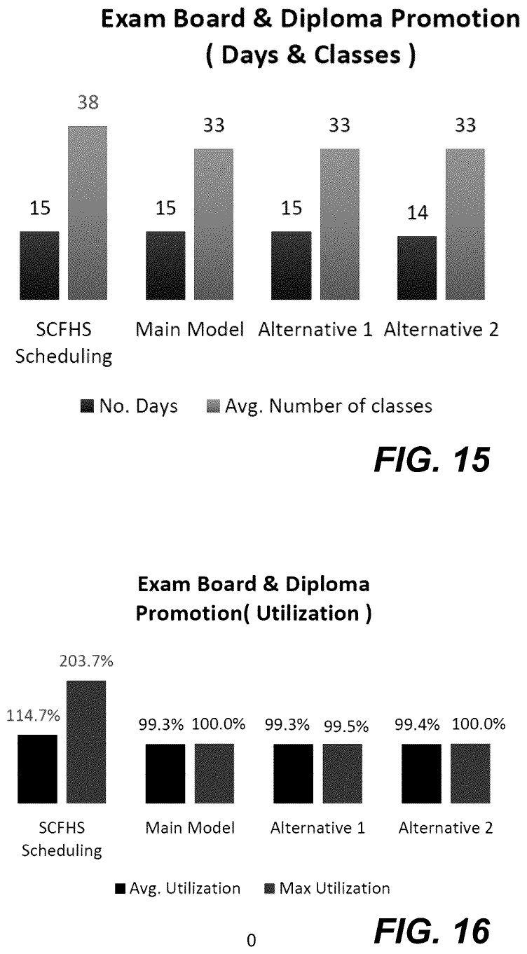

FIG. 15 is a graphic depiction of an example examination Days and Classes Chart for Examination Board and Diploma Promotion. FIG. 16 is a graphic depiction of an example examination utilization chart for Examination Board and Diploma Promotion.

Table 5 shows that Alternative 2 has nine days scheduling days for board and diploma final exams compared while the current system has less, which will be discussed later on the discussion section. The first alternative has less than 90% utilization lower than all other models. The current system has utilization above 100% on average, which is not a feasible system under normal circumstances.

TABLE 5
Board and Diploma Final Written examination period

| | SCFHS | | | |
|---|---|---|---|---|
| | (manual | | | |
| MODEL | entry) | Main model | Alternative 1 | Alternative 2 |
| Avg. | 102.0% | 90.6% | 85.9% | 94.1% |
| utilization | | | | |
| Max. | 113.9% | 100% | 88.9% | 99.9% |
| utilization | | | | |
| No. days | 7 | 9 | 10 | 9 |
| Avg. no. | 34 | 30 | 29 | 31 |
| classes | | | | |

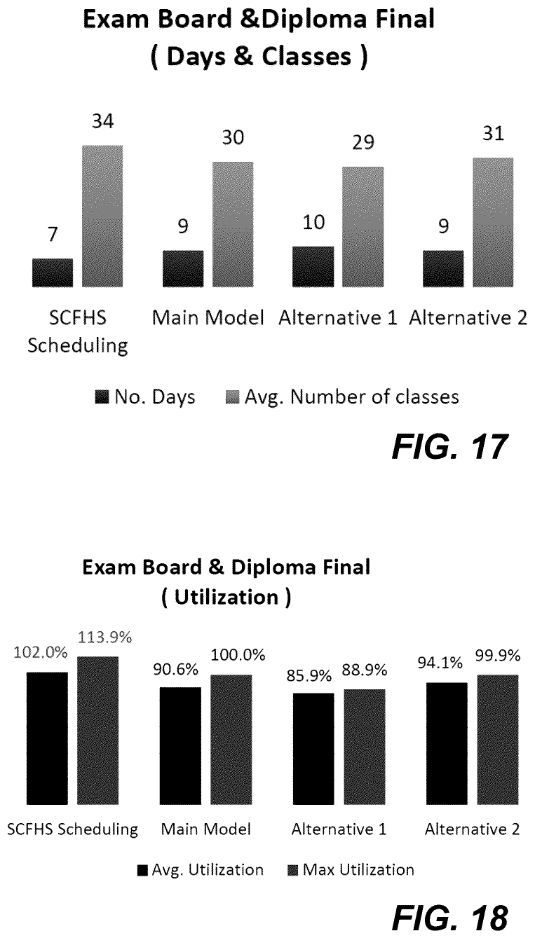

FIG. 17 is a graphic depiction of an example Final Days and Classes Chart for Board and Diploma examinations. FIG. 18 is a graphic depiction of an example utilization chart for Board and Diploma examinations.

Table 6 shows Fellowship and Diploma Promotion comparisons for the main model, Alternative 1 and Alternative 2:

TABLE 6
Fellowship and Diploma Promotion Comparisons

| | SCFHS | | | |
|---|---|---|---|---|
| | (manual | | | |
| MODEL | entry) | Main model | Alternative 1 | Alternative 2 |
| Avg. | 84.4% | 94.4% | 78.1% | 86.5% |
| utilization | | | | |
| Max. | 87.8% | 100% | 78.1% | 99.2% |
| utilization | | | | |
| No. days | 5 | 4 | 5 | 4 |
| Avg. no. | 28 | 31 | 26 | 29 |
| classes | | | | |

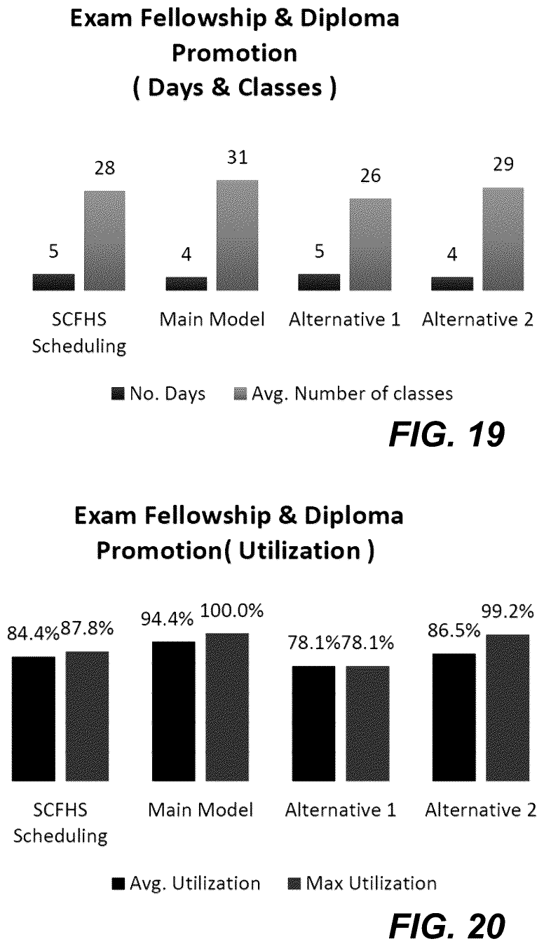

FIG. 18 is a graphic depiction of an example final Days and Classes Chart for Fellowship and Diploma Promotion. FIG. 19 is a graphic depiction of an example utilization chart for Fellowship and Diploma Promotion.

From Table 6, one can see that Alternative 2 has nine days scheduling days for board and diploma final exams compared while the current system has less, which will be discussed later on the discussion section. The first alternative has less than 90% utilization lower than all other models. The current system has utilization above 100% on average, which is not a feasible system under normal circumstances.

Table 7 shows Fellowship and Diploma Promotion comparisons for the main model, Alternative 1 and Alternative 2:

TABLE 7
Fellowship and Diploma Final Written Comparisons

| | SCFHS | | | |
|---|---|---|---|---|
| | (manual | | | |
| MODEL | entry) | Main model | Alternative 1 | Alternative 2 |
| Avg. | 79.7% | 81.6% | 72.3% | 92.1% |
| utilization | | | | |
| Max. | 83.8% | 100% | 72.3% | 98.8% |
| utilization | | | | |
| No. days | 4 | 3 | 4 | 3 |
| Avg. no. | 26 | 27 | 24 | 31 |
| classes | | | | |

FIG. 19 is a graphic depiction of an example of a final Days and Classes Chart for Fellowship and Diploma promotion. FIG. 20 is a graphic depiction of an example utilization chart for Fellowship and Diploma Final promotion.

Table 8 shows that Alternative 2 has three days, which is the least number of scheduling days for fellowship and diploma final exams compared to other models and the current system but the same as the main model. The first alternative has less than 75% utilization lower than all other models. The current system has utilization less than 80% on average, which is similar to the main model except that it has less maximum utilization.

Table 8 shows Fellowship and Diploma Final Written Examination comparisons for the main model, Alternative 1 and Alternative 2:

TABLE 6
Board and Diploma Final Written examination period

| | SCFHS | | | |
|---|---|---|---|---|
| | (manual | | | |
| MODEL | entry) | Main model | Alternative 1 | Alternative 2 |
| Avg. | 102.0% | 90.6% | 85.9% | 94.1% |
| utilization | | | | |
| Max. | 113.9% | 100% | 88.9% | 99.9% |
| utilization | | | | |
| No. days | 7 | 9 | 10 | 9 |
| Avg. no. | 34 | 30 | 29 | 31 |
| classes | | | | |

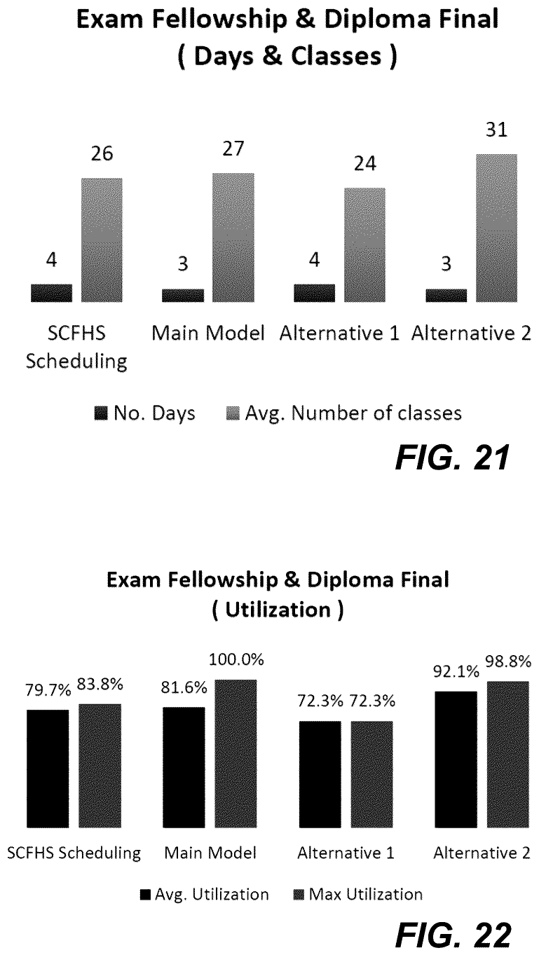

FIG. 21 is a graphic depiction of an example of a final Days and Classes Chart for Fellowship and Diploma Final Written Examination. FIG. 22 is a graphic depiction of an example of a Final Utilization Chart for Fellowship and Diploma Final Written Examination.

The Developed model provides efficient results that can be adjusted to accommodate different objectives. As shown in Table 5, the model can provide an error-free full schedule with all the constraints encompassed and within minutes which is a tremendous difference of more than 99% compared to the current system, which takes around a month. The main model has a similar result to the current system while not exceeding the capacity, unlike the current system that requires special post-processing of the schedule on many occasions; this will be discussed further on the limitation. The first alternative provides a schedule that has the least utilization with a reduction for average utilization of up to 15.75% compared to the current system, and it also has the highest number of days compared to all other models and the current system as well. The second alternative, on the other hand, has the lowest number of scheduling days across all programs except Board and Diploma Final written due to the presence of Final clinical exams, which are out of the scope of this model. These numbers are 6% to 25% less than the current system scheduling days; this decrease will ultimately lead to decreasing operational costs for SCFHS centers.

The disclosed techniques addresses limitations in the manual scheduling system, which include:
The current system breaches many constraints which affect the comparisons.
The current objective function of the model is based on an ambiguous strategic goal which is Examinees' satisfaction which is translated based on assumptions.
The current system permits scheduling exams that are higher than the capacity.

The disclosed technique addresses these limitations on assumptions that include:
The examinees' satisfaction can be achieved by increasing the ability to pick the exams on the desired center which can be done by minimizing the utilization of any examination day.
The exams demand that exceeds the allowed limits of participants for each exam, which can be easily adjusted by the disclosed techniques.

The results achieved in all these cases demonstrated that the proposed methods outperformed in terms of accuracy and computational time. Furthermore, these improvements were accomplished by employing Python Gurobi.

It is anticipated that further refinements in the implementation of this model will further save time and reduce overall costs. Further improvements can be made by obtaining more detailed information about examination capacity, for example the number of examinees for each examination type, to enhance the precision of the scheduling process. The model can be improved by minor modifications to the objective function and adding performance matrices as constraints, which could result in optimized scheduling based on examinee preferences for examination centers. In addition, the chosen optimization performance matrix could also reduce the required staff and monitors, leading to an overall cost reduction.

### CLOSING STATEMENT

It is anticipated that further refinements in the implementation of this model will further save time and reduce overall costs. Further improvements can be made by obtaining more detailed information about examination capacity, for example the number of examinees for each examination type, to enhance the precision of the scheduling process. The model can be improved by minor modifications to the objective function and adding performance matrices as constraints, which could result in optimized scheduling based on examinee preferences for examination centers. In addition, the chosen optimization performance matrix could also reduce the required staff and monitors, leading to an overall cost reduction.

It will be understood that many additional changes in the details, steps and processing criteria, which have been herein described and illustrated to explain the nature of the subject matter, may be made by those skilled in the art within the principle and scope of the invention as expressed in the appended claims.

1. A method for examination scheduling optimization for scheduling qualification or certification examinations of candidates, the method comprising:
identifying one or more scheduling qualification or certification examinations of candidates;
identifying an examination type, and demand, examination completion timeframes, examination administration capabilities, physical facility capacities, and examination specialty type for the examination type;
construction of a Mixed Integer Linear Programming (MILP) mathematical model, wherein the MILP model includes data collection and analysis from general data and further includes accounting from data representing said demand, examination completion timeframes, examination administration capabilities, physical facility capacities, and examination specialty type for the examination type;
performing an evaluation using the MILP model to optimize scheduling qualification or certification examinations of the candidates, while meeting criteria for required parameters, fixed parameters, or parameters representing difficult-to-adjust conditions, to obtain optimized scheduling, wherein the predetermined optimization formula provides optimization values for each parameter; and
administering said qualification or certification examinations according to a predetermined optimization formula, while meeting criteria for required parameters, fixed parameters, or parameters representing said conditions, said conditions comprising:
completion parameters comprising:
all examinations are to be scheduled within a predetermined time limit;
all examinations are scheduled after a starting date;
all specialties examinees are allocated to their perspective examinations;
capacity parameters comprising:
the examination completion scheduling exclude official off days from available days;
a number of examinees is less than or equal to the number of available seats; and
specification and exclusion parameters comprising:
consolidation of scheduling for specialties with the same examination type and program, except the diploma;
consolidation of scheduling for predetermined set of diploma specialties;
professional practice examinations run throughout the year except for s predetermined set of excluded days;
post-graduation programs are scheduled according to a sequence of:
1. an initial examination;
2. promotion examination; and
3. final written examination.

2. The method as described in claim 1, wherein at least one criterion for optimization aims to balance resource utilization to enhance examinee satisfaction.

3. The method as described in claim 1, wherein at least one criterion for optimization aims to maximize utilization of specific examination types to reduce the number of days required for scheduling.

4. The method as described in claim 1, further comprising:
executing the MILP model by using Python Gurobi software implementing the Gurobi Optimizer platform for said executing an evaluation using the MILP model.

5. The method as described in claim 1, further comprising:
using the MILP model as an MILP solver that uses the MILP model to solve mixed integer linear programs with the new input data to be solved in three phases:
Phase 1: Optimize the number of days required for each examination;
Phase 2: Optimize the written examination schedules given the number of days from Phase 1, demand and capacity; and
Phase 3: Optimize the clinical examinations based on written examination schedules set in Phase 2.

6. The method as described in claim 5, further comprising:
in Phase 1, using the model finds the examination completion timeframes required to perform the written examinations for each specialty based on the physical facility capabilities and the number of examinees;
in Phase 2, using the model to evaluate the examination completion timeframes, and to schedule further examinations; and
in Phase 3, identify examination dates for each program, level, and type.

7. A system, for examination scheduling optimization for scheduling qualification or certification examinations of candidates, comprising:
at least one processor and memory; and
executable code on nontransient media with instructions for the processor to:
identify one or more scheduling qualification or certification examinations of candidates;
identify an examination type, and demand, examination completion timeframes, examination administration capabilities, physical facility capacities, and examination specialty type for the examination type;
construct a Mixed Integer Linear Programming (MILP) mathematical model, wherein the MILP model includes data collection and analysis from general data and further includes accounting from data representing said demand, examination completion timeframes, examination administration capabilities, physical facility capacities, and examination specialty type for the examination type;
perform an evaluation using the MILP model to optimize scheduling qualification or certification examinations of the candidates, while meeting criteria for required parameters, fixed parameters, or parameters representing difficult-to-adjust conditions, to obtain optimized scheduling, wherein the predetermined optimization formula provides optimization values for each parameter; and
administer said qualification or certification examinations according to a predetermined optimization formula, while meeting criteria for required parameters, fixed parameters, or parameters representing said conditions, said conditions comprising:
completion parameters comprising:
all examinations are to be scheduled within a predetermined time limit;
all examinations are scheduled after a starting date;
all specialties examinees are allocated to their perspective examinations;
capacity parameters comprising:
the examination completion scheduling exclude official off days from available days;
a number of examinees is less than or equal to the number of available seats; and
specification and exclusion parameters comprising:
consolidation of scheduling for specialties with the same examination type and program, except the diploma;
consolidation of scheduling for predetermined set of diploma specialties;
professional practice examinations run throughout the year except for s predetermined set of excluded days;
post-graduation programs are scheduled according to a sequence of:
1. an initial examination:
2. promotion examination; and
3. final written examination.

8. The system of claim 7, wherein the execution of executing the MILP model includes using Python Gurobi software implementing the Gurobi Optimizer platform for said executing an evaluation using the MILP model.

9. The system of claim 7, further comprising:
the MILP model as an MILP solver that uses the MILP model to solve mixed integer linear programs with the new input data implements the optimization of scheduling qualification or certification examinations of the candidates in three phases:
Phase 1: Optimize the number of days required for each examination;
Phase 2: Optimize the written examination schedules given the number of days from Phase 1, demand and capacity; and
Phase 3: Optimize the clinical examinations based on written examination schedules set in Phase 2.

10. The system of claim 9, wherein:
in Phase 1, the model finds the examination completion timeframes required to perform the written examinations for each specialty based on the physical facility capabilities and the number of examinees;
in Phase 2, the model evaluates the examination completion timeframes, and schedules further examinations; and
in Phase 3, the model identifies examination dates for each program, level, and type.
